(19) United States
(12) Patent Application Publication
(10) Pub. No.: US 2012/0162547 A1
(43) Pub. Date: Jun. 28, 2012

(54) VIDEO DISPLAY DEVICE

(75) Inventor: Kenshi Tsuchiya, Kumagaya-shi (JP)

(73) Assignee: KABUSHIKI KAISHA TOSHIBA, Tokyo (JP)

(21) Appl. No.: 13/300,299

(22) Filed: Nov. 18, 2011

(30) Foreign Application Priority Data
Dec. 24, 2010 (JP) 2010-288647

(51) Int. Cl. H04N 5/64

(52) U.S. Cl. 348/836; 348/E05.129

(57) ABSTRACT

According to one embodiment, a video display device includes a housing, a display module, a wall portion, a first circuit board and a second circuit board. The housing houses at least part of the display module. The wall portion is located opposite the display screen with respect to the display module. The first circuit board includes an input signal processing circuit that outputs at least video data from an input signal. The second circuit board includes a frame rate converter circuit and a timing control circuit. The frame rate converter circuit generates an interpolation frame based on frames of the video data received from the input signal processing circuit and outputs the video data with an increased frame rate. The timing control circuit outputs a timing control signal to a driver circuit that drives the display module based on the video data received from the frame rate converter circuit.

### CROSS-REFERENCE TO RELATED APPLICATIONS

This application is based upon and claims the benefit of priority from Japanese Patent Application No. 2010-288647, filed Dec. 24, 2010, the entire contents of which are incorporated herein by reference.

### FIELD

Embodiments described herein relate generally to a video display device.

### BACKGROUND

There have been known video display devices provided with a frame rate converter circuit and a timing control circuit at the latter stage. In general, the frame rate converter circuit and the timing control circuit are provided separately on different circuit boards.

Because of an increase in data transfer amount per unit time in the frame rate converter circuit, if the frame rate converter circuit and the timing control circuit are located on different circuit boards, many cables need to be provided between the circuit boards. This may arise some inconvenience such as an increase in manufacturing process and cost.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary front view of a video display device according to a first embodiment;

FIG. 2 is an exemplary side view of the video display device in the first embodiment;

FIG. 3 is an exemplary schematic exploded perspective view of a portion of the main body of the video display device in the first embodiment;

FIG. 4 is an exemplary schematic block diagram of the circuitry of the video display device in the first embodiment;

FIG. 5 is an exemplary back view of the video display device without a back cover in the first embodiment;

FIG. 6 is an exemplary plan view of a second circuit board of the video display device in the first embodiment;

FIG. 7 an exemplary schematic block diagram of the circuitry of a video display device according to a second embodiment; and

FIG. 8 is an exemplary back view of the video display device without a back cover in the second embodiment.

### DETAILED DESCRIPTION

In general, according to one embodiment, a video display device comprises a housing, a display module, a wall portion, a first circuit board and a second circuit board. The display module comprises a display screen and is configured to be at least partly housed in the housing. The wall portion is located opposite the display screen with respect to the display module. The first circuit board is located on a surface of the wall portion opposite the display screen. The first circuit board comprises an input signal processing circuit configured to output at least video data from an input signal. The second circuit board is located on the surface. The second circuit board comprises a frame rate converter circuit and a timing control circuit. The frame rate converter circuit is configured to generate an interpolation frame based on frames of the video data received from the input signal processing circuit and output the video data with an increased frame rate. The timing control circuit is configured output a timing control signal to a driver circuit that drives the display module based on the video data received from the frame rate converter circuit.

Exemplary embodiments will be described in detail below with reference to the accompanying drawings, in which, for the sake of convenience, directions are defined as follows: X direction indicates the left direction in the front view of the display screen (the right direction in the back view); Y direction indicates the up direction; and Z direction indicates the normal direction of the display screen. In the following, like reference numerals refer to like parts, and redundancy is avoided in the description.

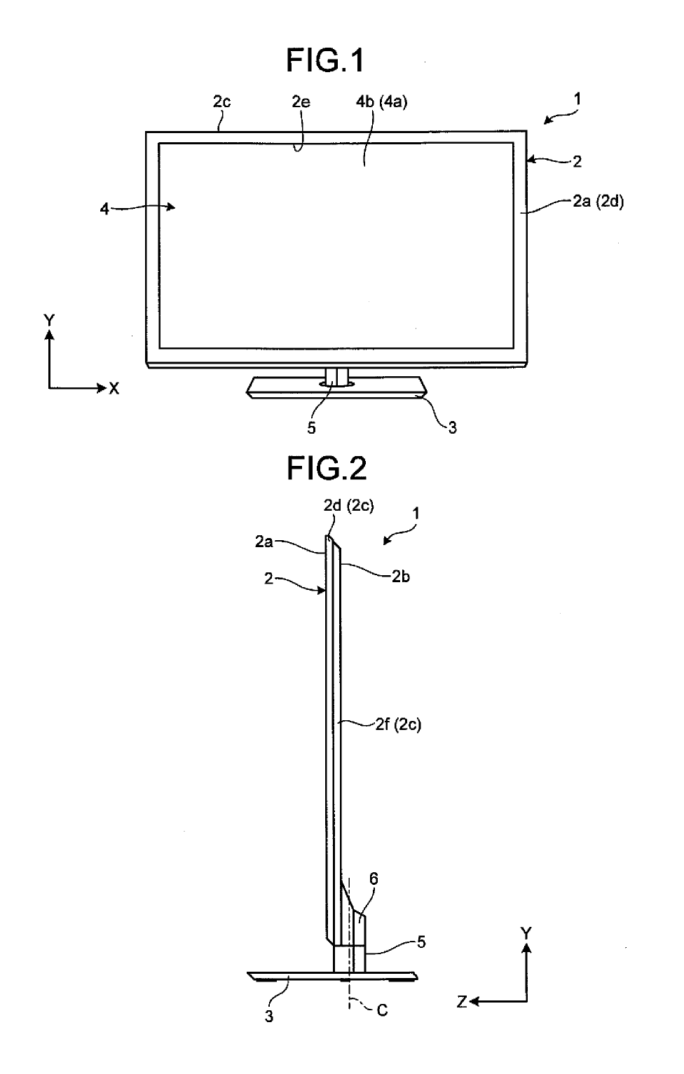

As illustrated in FIGS. 1 and 2, a video display device 1 of a first embodiment will be described by way of example as a television receiver. The video display device 1 comprises a base 3 and a relatively thin flat rectangular main body 2. The main body 2 is supported on the base 3 via a leg 5 and an attachment portion 6. The main body 2 comprises a housing 2c on a front surface 2a of which is provided a rectangular opening 2e. The housing 2c houses therein a display module 4 (a display unit 8) having a display screen 4a that is exposed from the opening 2e. The display module 4 may be, for example, a liquid crystal display (LCD) panel or an organic electroluminescent display (GELD) panel.

For example, the housing 2c is formed of a combination of parts such as a front mask 2d on the front surface 2a side and a back cover 2f on the side of a back surface 2b. The attachment portion 6 protrudes from the back surface 2b toward the back, and is supported by the leg 5 to be rotatable about the rotation axis C.

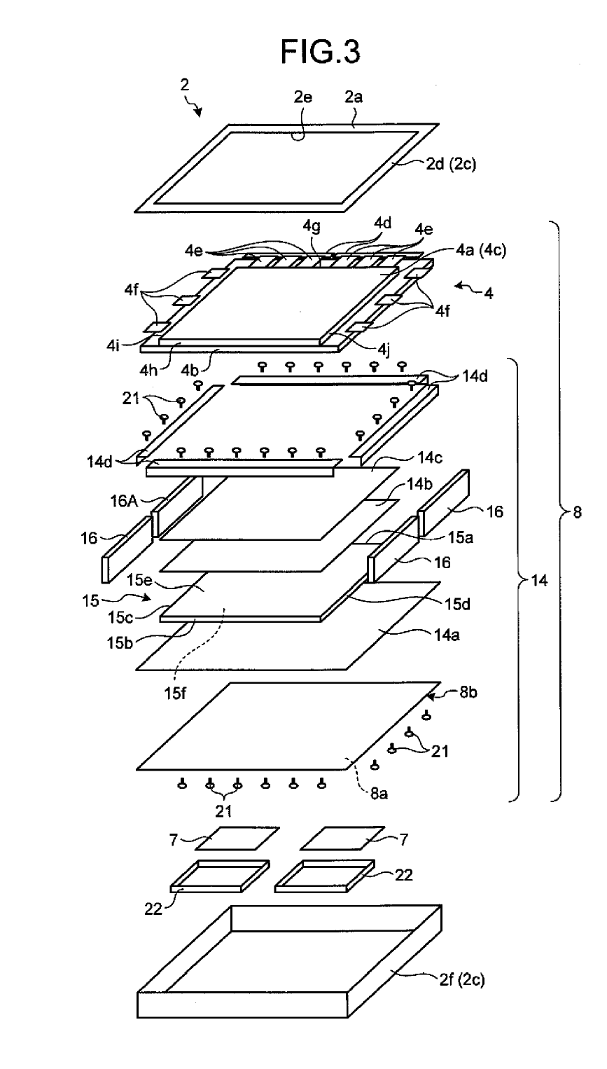

As illustrated in FIG. 3, in the first embodiment, the housing 2c comprises the front mask 2d and the back cover 2f. The housing 2c houses therein the display unit 8 comprising the display module 4 and a backlight 14 (backlight mechanism). After the backlight 14 is assembled into a backlight unit, the backlight unit (the backlight 14) may be assembled with the display module 4 to form the display unit 8. Parts are assembled with screws 21.

The display module 4 comprises a base portion 4b, a panel 4c, a source board 4d, a source chip-on-film (COF) 4e, a gate COF 4f, and the like.

The backlight 14 comprises a back plate 8b, a reflective layer 14a, a light guide 15, a prism layer 14b, a polarization layer 14c, a frame 14d, light emitting modules 16, and the like. All the back plate 8b, the reflective layer 14a, the light guide 15, the prism layer 14b, and the polarization layer 14c have a flat rectangular shape in the front view, and are layered in the order as illustrated in FIG. 3.

In the first embodiment, among edges 15a to 15d of the light guide 15, the light emitting modules 16 each having a plurality of light emitters, such as light emitting diodes (LEDs) (not illustrated), are located along the edges 15c and 15d facing each other on horizontally opposite sides such that they are spaced apart from the edges 15c and 15d, respectively. Among edges 4g to 4j of the display module 4, the edges 15c and 15d extend along the edges 4i and 4j facing each other on horizontally opposite sides, i.e., left and right sides (see FIG. 3). Accordingly, the light emitting modules 16 and the light emitters also extend along the edges 4i and 4j of the display module 4.

The light emitters provided to the light emitting modules 16 are arranged, for example, in a line along the edges 15c and 15d to face the edges 15c and 15d. The light emitted from the light emitters enters the plate-like light guide 15 from the edges 15c and 15d thereof and is emitted from a front surface 15e. The reflective layer 14a is located on the side of a back surface 15f. With this, the light emitted from the back surface 15f is reflected on the reflective layer 14a, returns into the light guide 15, and is emitted from the front surface 15e. The light emitted from the front surface 15e passes though the prism layer 14b and the polarization layer 14c and illuminates the back surface of the display module 4 (the display screen 4a) as backlight. The frame 14d is made of a material with relatively high rigidity (for example, metal material, etc.), and functions as the housing of the backlight 14 and the display unit 8 together with the back plate 8b and ribs 9 (see FIG. 5).

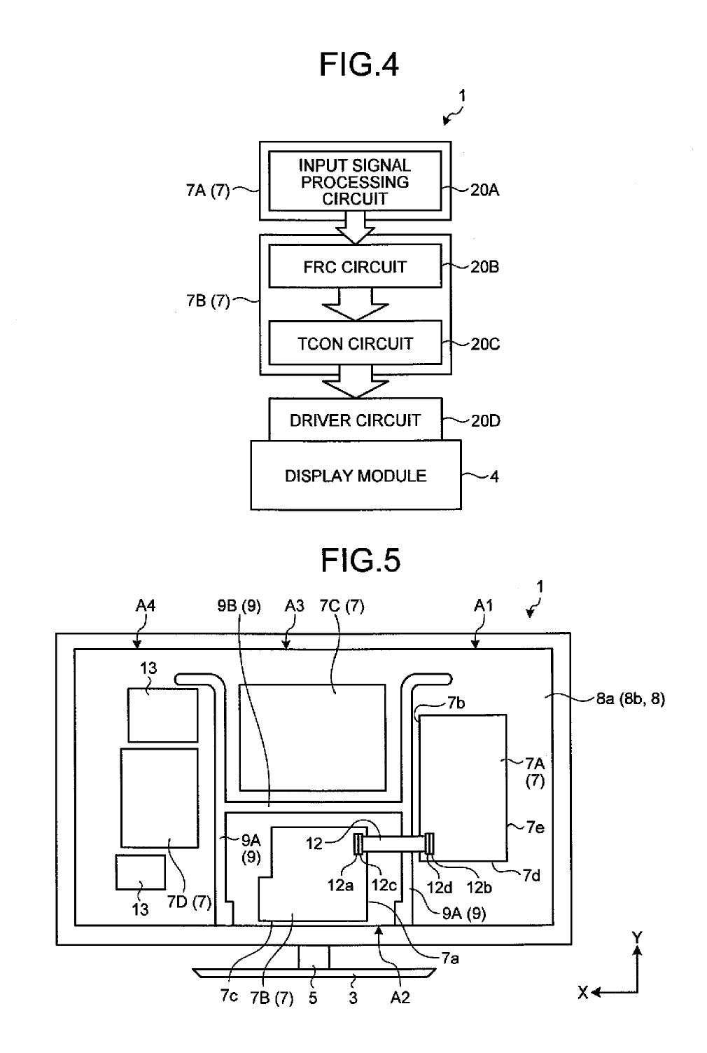

FIG. 4 illustrates an example of the circuitry of the video display device 1 of the first embodiment. As illustrated in FIG. 4, the video display device 1 comprises an input signal processing circuit 20A, a frame rate converter (FRC) circuit 20B, a timing control (Tcon) circuit 20C, a driver circuit 20D, and the display module 4.

The input signal processing circuit 20A comprises a tuner, a connector, and the like (all not illustrated). The input signal processing circuit 20A processes a signal received from a component such as an antenna, audio visual (AV) equipment, or the like, and outputs video data and audio data. The input signal processing circuit 20A is capable of various types of video processing, correction, video composition, and the like.

The FRC circuit 20B receives the video data from the input signal processing circuit 20A. The FRC circuit 20B converts the frame rate of the video by, for example, generating an interpolation frame based on the motion vector of the video. The FRC circuit 20B is capable of processing to generate three-dimensional (3D) video, to increase the definition, and the like. The amount of video data output from the FRC circuit 20B per unit time increases in proportion to input video data.

The Tcon circuit 20C receives the video data from the FRC circuit 20B, and generates a timing signal to control the driver circuit 20D (XY driver) at the latter stage. Then, the Tcon circuit 20C outputs the video data and the timing signal.

The driver circuit 20D (XY driver) drives the display module 4 or a plurality of thin-film transistors (TFTs) of the display module 4 to display the video on the display module 4 based on the signal received from the Tcon circuit 20C.

As illustrated in FIG. 4, in the first embodiment, the input signal processing circuit 20A is provided to a first circuit board 7A, while the FRC circuit 20B and the Tcon circuit 20C are provided to a second circuit board 7B. The Tcon circuit 20C needs to match the performance and characteristics of the driver circuit 20D and the display module 4. Therefore, it is often the case that the manufacturer (supplier) of the driver circuit 20D and the display module 4 develops or manufactures the Tcon circuit 20C. On the other hand, the FRC circuit 20B is additionally provided with functions of enhancing resolution, definition, features, added value, and the like. Therefore, it is often the case that the manufacturer of the video display device 1 (the assembly maker of the video display device 1) develops or manufactures the FRC circuit 20B. For this reason, according to conventional technologies, the FRC circuit 20B and the Tcon circuit 20C are often provided separately on different circuit boards, and connected by cables (e.g., twisted pair cables causing less mutual interference, etc.). With such a conventional structure, as described above, because of an increase in data transfer amount per unit time in the FRC circuit 20B, the number of cables tends to increase. This is a factor to increase the manufacturing process and cost. In view of this, according to the first embodiment, the FRC circuit 20B and the Tcon circuit 20C are provided to one circuit board 7 (second circuit board 7B). This eliminates the need of a cable necessary for (data transfer in) a section where a large amount of data is transferred if the FRC circuit 20B and the Tcon circuit 20C are provided separately to different circuit boards.

In the first embodiment, as illustrated in FIG. 5, a plurality of circuit boards 7 (7A to 7D) are attached by fasteners such as screws (not illustrated) onto a back surface 8a of the display unit 8 (i.e., the surface opposite the display screen 4a). The circuit boards 7 are each fixed on a boss (not illustrated) protruding on the back surface 8a. Thus, there is a space between the circuit boards 7 and the back surface 8a.

The back surface 8a of the display unit 8 corresponds to the back plate 8b as a wall portion. The back plate 8b is provided with the ribs 9 (9A, 9B) arranged in an H-shape in the back view. The ribs 9 (9A, 9B) protrude on the back surface 8a. The ribs 9A (first ribs) are arranged in parallel to each other in the horizontal center of the back plate 8b as being spaced apart in the horizontal direction and extending in the vertical direction. The rib 9B (second ribs) is a bridge between the vertical centers of the two ribs 9A and extends in the horizontal direction. The ribs 9A and 9B are portions (reinforcement portions, frame portions) that structurally reinforce the display unit 8. The ribs 9A and 9B may be formed by partly bending the back plate 8b by pressing or the like, or by adding other parts. The ribs 9A and 9B may also be formed by partly bending the back plate 8b and then adding other parts. The ribs 9 (for example, the ribs 9A) are provided with a coupling portion such as a boss or a screw hole (not illustrated) for video electronics standard association (VESA: registered trademark) mounting, i.e., for wall hanging.

As illustrated in FIG. 5, the ribs 9A and 9B arranged in an H-shape divide the back surface 8a of the display unit 8 into areas A1 to A4. In the back view (i.e., in the view of FIG. 5), the area A1 is located on the right side of the right rib 9A, the area A2 and the area A3 are located below and above the rib 9B, respectively, in the horizontal center, and the area A4 is located on the left side of the left rib 9A. The circuit boards 7 (7A to 7D), components 13, and the like are arbitrarily distributed to the areas A1 to A4.

For example, the circuit boards 7A to 7D (first to fourth circuit boards) are installed in the areas A1 to A4, respectively. The components 13, such as a hard disk drive (HDD), a speaker, and the like, are provided to the area A4. Incidentally, as illustrated in FIG. 3, each of the circuit boards 7 may be covered with a shield case 22.

As illustrated in FIG. 4, the circuit board 7A is provided with the input signal processing circuit 20A (see FIG. 4), while the circuit board 7B is provided with the FRC circuit 20B, the Tcon circuit 20C, and the like. As illustrated in FIG. 5, the circuit boards 7A and 7B are arranged such that the right rib 9A is located between them.

In the first embodiment, the circuit boards 7A and 7B are connected to each other via a flat cable 12 that may be, for example, flexible printed circuits (FPC) or a flexible flat cable (FFC). As described above, the rib 9A is located between the circuit boards 7A and 7B and protrudes backward. As a result, the space between the back plate 8b as a wall portion and the back cover 2f as the back wall of the housing 2c is narrower than where the rib 9 does not exist. In the first embodiment, with the structure as illustrated in FIG. 4, the data transfer amount between the circuit boards 7A and 7B is relatively small before being increased in the FRC circuit 20B. Because of this, the flat cable 12 can be used as a cable to electrically connect the circuit boards 7A and 7B. Thus, according to the first embodiment, the cable (the number of cables, the thickness of the cable, etc.) can be prevented from being an obstacle to making the housing 2c thinner and improving the rigidity and strength. Besides, compared to the conventional structure in which circuit boards are connected by many twisted pair cables, it is possible to reduce the manufacturing process and cost.

According to the first embodiment, the circuit board 7A that is provided with the input signal processing circuit 20A is located not in the horizontal center area A2 or A3 but in the horizontal side area A1 or A4 (in the first embodiment, in the area A1). That is, the circuit board 7A is located opposite the circuit board 7B with respect to one of the ribs 9A (in the first embodiment, the rib right 9A). The circuit board 7A is provided with a plurality of connectors for, for example, external connection (not illustrated) along the edges (the periphery, for example, edges 7d and 7e in FIG. 5, etc.). If the connectors are exposed from the space (opening) between the back cover 2f and the back plate 8b, arranging the circuit board 7A in the area A1 facilitates the edges of the circuit board 7A (the periphery, for example, the edges 7d and 7e in FIG. 5, etc.) to extend along the periphery of the back plate 8b. Thus, the space (opening) can be more easily provided.

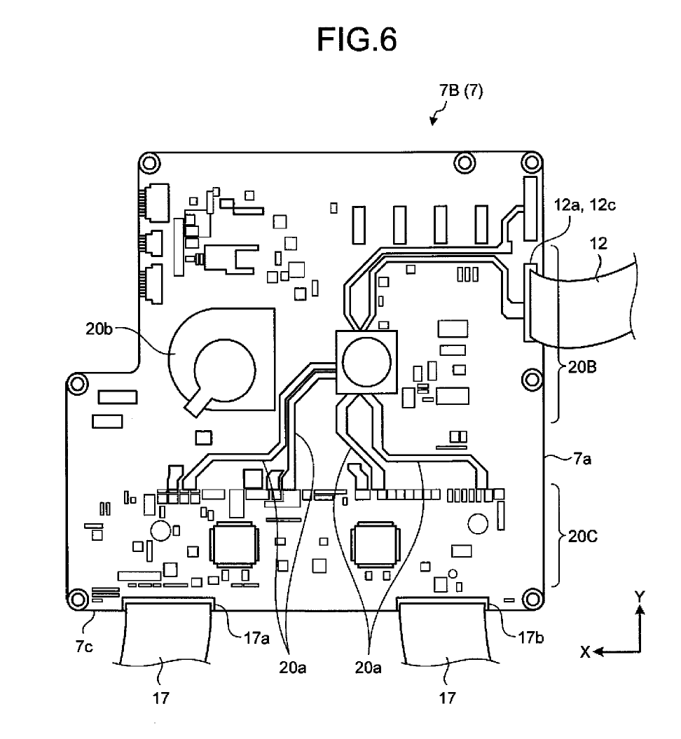

Further, as illustrated in FIG. 6, in the circuit board 7B, the FRC circuit 20B is located above the Tcon circuit 20C. The circuit board 7B is provided with a connector 12a at an edge 7a facing the rib 9A (the right rib 9A). Besides, as illustrated in FIG. 5, the circuit board 7A is provided with a connector 12b at an edge 7b facing the rib 9A (the right rib 9A). The connector 12a is connected to a connector 12c of the flat cable 12, while the connector 12b is connected to a connector 12d of the flat cable 12. This electrically connects between the input signal processing circuit 20A and the FRC circuit 20B.

As illustrated in FIG. 6, the FRC circuit 20B and the Tcon circuit 20C are electrically connected by a plurality of conductor patterns 20a provided to the circuit board 7B. The conductor patterns 20a enables a compacter structure at a lower cost compared to the case of using cables. As illustrated in FIG. 6, in the first embodiment, a cooling fan 20b is provided in the vertical center of the circuit board 7B, i.e., at the boundary between the FRC circuit 20B and the Tcon circuit 20C. Thus, the cooling fan 20b can be shared between two circuits, i.e., the FRC circuit 20B and the Tcon circuit 20C.

Although not illustrated, the driver circuit 20D is arranged horizontally at a position along the lower edge of the display module 4 below the circuit board 7B. Since the driver circuit 20D extends over the horizontal direction, preferably, the Tcon circuit 20C is arranged near the horizontal center. From the viewpoint of the position of the Tcon circuit 20C, the layout of the first embodiment is desirable, in which the circuit board 7B is located in the horizontal center area A2 and the Tcon circuit 20C is arranged on the lower side of the circuit board 7B. Incidentally, as illustrated in FIG. 6, at a lower edge 7c of the circuit board 7B are arranged connectors 17a and 17b of flat cables 17 for electrical connection between the Tcon circuit 20C and the driver circuit 20D.

The circuit board 7C (third circuit board) in the upper horizontal center area A3 is provided with a power source circuit (not illustrated) including at least a digital-to-analog (DA) converter. The arrangement of the power source circuit in the horizontal center area achieves a shorter power supply cable (not illustrated) that is routed between the circuit board 7C and the circuit boards 7A, 7B, and 7D. Further, the arrangement of the circuit board 7C on the upper side allows heat generated by the power source circuit to be discharged upward easier compared to the case where the circuit board 7C is arranged on the lower side. This facilitates to suppress the influence of the heat on other parts (for example, the circuit boards 7A, 7B, and 7D).

As illustrated in FIG. 5, according to the first embodiment, the circuit board 7B is located in the lower horizontal center area A2, while the circuit board 7C is located in the upper horizontal center area A3. With this, the rib 9B between the circuit boards 7B and 7C can connect between the vertical centers of the two ribs 9A, which facilitates to improve the rigidity and strength of the back plate 8b. In addition, since the circuit board 7C in the area A3 is located above the circuit board 7B in the area A2 in the horizontal center, it is possible to prevent heat generated by the power source circuit in the circuit board 7C from affecting the circuit board 7B.

The circuit board 7D (fourth circuit board) in the left area A4 is provide with a light-emitter driver circuit (not illustrated) that controls the light emission of a plurality of light emitters provided to the light emitting modules 16. That is, according to the first embodiment, the relatively large circuit boards 7A to 7D can be effectively arranged in the four areas A1 to A4 formed on the back surface 8a of the back plate 8b as a wall portion by the ribs 9 in a substantially H-shape.

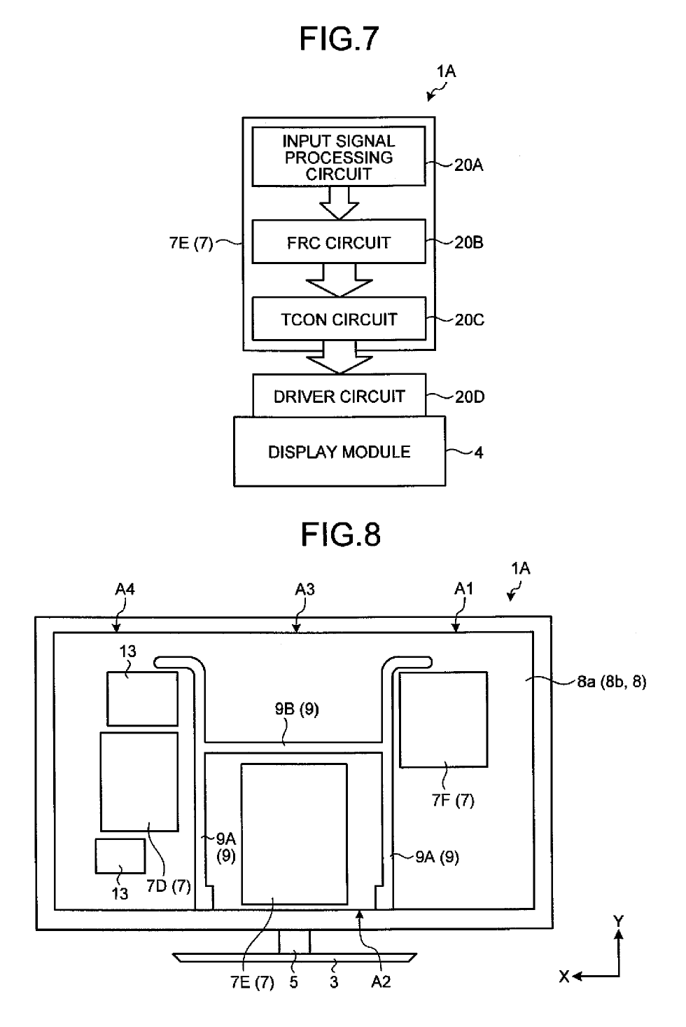

As illustrated in FIG. 7, a video display device 1A of a second embodiment comprises a circuit board 7E (fifth circuit board) provided with the input signal processing circuit 20A with the FRC circuit 20B and the Tcon circuit 20C. This structure can achieve the same effect as previously described in the first embodiment.

As illustrated in FIG. 8, in the second embodiment, a circuit board 7F (sixth circuit board) provided with a power source circuit (not illustrated) is arranged on a horizontal side (in the second embodiment, the right side) of the circuit board 7E. This prevents heat generated by the power source circuit from affecting the circuit board 7E. In the second embodiment, the circuit board 7F is arranged on the upper side, and this arrangement can suppress the influence of the heat generated by the power source circuit on other parts such as the circuit board 7E.

Regarding the video display device, the housing, the display module, the wall portion, the rib, various circuits, the circuit board, the light guide, the light emitting module, the light emitter, the conductor pattern, the component, the element, and the like, the specifications (structure, vertical/horizontal direction, shape, size, length, width, thickness, height, number, arrangement, location, material, etc.) can be suitably modified.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video display device comprising:
a housing;
a display comprising a display screen, the display in the housing;
a wall portion opposite the display screen with respect to the display;
a first circuit board on a first surface of the wall portion opposite the display screen, the first circuit board comprising an input signal processor configured to output at least video data based on an input signal; and
a second circuit board located on the first surface, the second circuit board comprising
a frame rate converter configured to generate an interpolation frame based on a plurality of frames of the video data received from the input signal processor, and to output the video data with an increased frame rate, and
a timing controller configured output a timing control signal to a driver configured to drive the display module, the timing control signal based on the video data received from the frame rate converter.

2. The video display device of claim 1, further comprising a rib protruding from the first surface and extending along the first surface,
wherein the rib is between the first circuit board and the second circuit board.

3. The video display device of claim 2, wherein
the rib comprises two first ribs, substantially horizontally centered on the first wall portion, spaced apart in a horizontal direction, and extending in a vertical direction,
the second circuit board is between the two first ribs, and
the first circuit board is opposite the second circuit board with respect to one of the first ribs.

4. The video display device of claim 3, further comprising a third circuit board located on the first surface above the second circuit board, the third circuit board comprising a power source.

5. The video display device of claim 4, further comprising a second rib configured to bridge the first ribs, wherein:
the second circuit board is below the second rib, and
the third circuit board is above the second rib.

6. The video display device of claim 3, wherein the frame rate converter is above the timing controller in the second circuit board.

7. The video display device of claim 3, further comprising:
a backlight comprising a light guide between the display and the wall portion, and a light emitter configured to provide light to the light guide; and
a fourth circuit board on the first surface, the fourth circuit board comprising a light-emitter driver configured to supply power to, and turn on the light emitter, wherein
the fourth circuit board is opposite the first circuit board with respect to one of the first ribs.

8. A video display device comprising:
a housing;
a display comprising a display screen, the display in the housing;
a housing at least partly housing the display;
a wall portion opposite the display screen with respect to the display; and
a first circuit board on a first surface of the wall portion opposite the display screen, the first circuit board comprising:
an input signal processor configured to output at least video data based on an input signal,
a frame rate converter configured to generate an interpolation frame based on a plurality of frames of the video data received from the input signal processor, and to output the video data with an increased frame rate, and
a timing controller configured output a timing control signal to a driver configure to drive the display, the timing control signal based on the video data received from the frame rate converter.

9. The video display device of claim 8, further comprising a second circuit board on a horizontal side of the first circuit board, the second circuit board comprising a power source.

10. A video display device comprising:
a housing;
a display comprising a display screen, the display in the housing;
a first circuit board housed in the housing, the first circuit board comprising an input signal processor configured to output at least video data based on an input signal; and
a second circuit board housed in the housing, the second circuit board comprising:
a frame rate converter configured to receive the video data from the input signal processing circuit and to output the video data with an increased frame rate, and
a timing controller configured output a control signal to a driver of the display based on the video data received from the frame rate converter circuit.
